(19) United States
(12) Patent Application Publication
(10) Pub. No.: US 2015/0289453 A1
(43) Pub. Date: Oct. 15, 2015

(54) PLANT CULTIVATION APPARATUS

(71) Applicants: Kenneth Lewis, Santa Clara, UT (US); Phillip Dietz, Saint George, UT (US)

(72) Inventors: Kenneth Lewis, Santa Clara, UT (US); Phillip Dietz, Saint George, UT (US)

(21) Appl. No.: 14/746,784

(22) Filed: Jun. 22, 2015

Related U.S. Application Data
(62) Division of application No. 13/969,578, filed on Aug. 18, 2013.

(51) Int. Cl. A01G 9/02; A01G 27/00

(52) U.S. Cl. CPC A01G 9/028; A01G 27/005

(57) ABSTRACT

A planter reservoir and planter system which is easily converted for different planting environments. The planter reservoir is divided by a permeable partition into different areas. The lower area contains a canal with perforated walls. Multiple openings in the reservoir allow the users options to control liquids. The reservoir may be assembled into a planter system, where two reservoirs are connect by a mounting tray, clip, and handle forming an array.

### DOMESTIC PRIORITY

This application is a DIVISIONAL of and claim priority to U.S. application Ser. No. 13/969,578, filed Aug. 18, 2013, the contents of which are incorporated by reference in its entirety.

### BACKGROUND OF THE INVENTION

1. Field of the Invention

A plant cultivation apparatus that minimizes the labor and space typically required to cultivate plants.

2. Background—Prior Art

Gardening is an activity that is both essential to feed people and enjoyed as a hobby by people throughout history and the world. Generally, gardening has occurred outdoors in soils. However, as individual moved to the urban environment and as land values have increased, there are limited opportunities for individuals to garden. In areas where land is limited or the plants require individual attention, gardeners have used pots or planters for gardening. Historically, gardening with pots was very limited because the labor generally limited individuals to only a few plants. In addition, growing plants in pots requires special attention to provide the plants the correct growing conditions. If the gardener fails to provide proper care for the plant, the plant may die. When correctly cared for, plants in planters will generally thrive.

One attempt to increase the effectiveness of growing plants in planters is the use of hydroponics. Hydroponics is a method of growing plants using mineral nutrient solutions in water. Hydroponics generally does not utilize soil. However, the plants may still be supported by a growing medium. Mineral nutrient rich water is allowed to flow through the root structure of the plants so the plant roots can absorb the required nutrients. Hydroponics generally has been limited to large-scale production or does not take advantage of smaller scale production. In addition, hydroponics planters are generally specialized equipment which could not be used as a traditional planter.

As the demand for additional plant nutrition has grown with the increased world population, the need to grow food has intensified. There have been several attempts to simplify growing plants in planters. These prior inventions mostly have limited applications or require an extensive amount of labor. Another problem with the prior art planters is that they were not adaptable to different growing conditions.

What is needed is a planter that can easily be used as a traditional planter, but can also be easily converted to accommodate different growing condition including hydroponics and aquaponics. In addition, a planter system that allows a garden to stack multiple planter boxes or reservoirs in a very limited space, yet the planter system is sturdy to prevent the planters from falling.

### SUMMARY

The present invention provides a unique planter box or reservoir which can be combined with other reservoirs to form a planter system. The planter box has a removable permeable partition that separates the reservoir container into two different chambers. The upper chamber contains plant growing medium or soil. The lower chamber is generally open. There is a canal located in the bottom chamber. The canal has two walls that extend up into the planter. At least a portion of the canal walls is perforated. In addition, the bottom chamber has two openings or holes. One of the openings is located in the canal described above. The second opening is generally higher that the opening located in the canal. However, the location of the second opening may vary based upon the growing conditions desired by the gardener. In certain applications, the gardener may choose to plug the openings. The second opening may also be located on a raised platform.

The following is a few examples of the diversity of the invention. For conventional gardening, the permeable partition may be removed and the upper opening plugged. The lower opening in the canal would remain open and allowed to drain excess water. In the condition of aquaponics, both the upper and lower drains can be used and controlled to fill and drain nutrient rich water to satisfy the plans growing needs. This unique planter box or reservoir allows a gardener numerous different arrangements in one planter system.

The invention also includes a planter system that allows a garden to stack multiple planter boxes or reservoirs in a very limited space, yet the planter system is sturdy to prevent the planters from falling. The planter system also allows for the addition of accessories.

It is a principal object of the invention to provide an easily stackable planting system which takes advantage of unique planter containers that allows the gardener to easily adjust the growing conditions required by a plant. Still another object of the invention is to provide a planter that is formed from plastic to be attractive, easily cleaned, and cost effective in its manufacture.

### DESCRIPTION OF THE DRAWINGS

The invention may take form in certain parts and arrangement of parts, and preferred embodiment of which will be described in detail in the specification and illustrated in the accompanying drawing, which for a part hereof:

FIG. 1 shows a side plan view of the planter system of the invention, showing the top array connected to the lower array;

FIG. 2 shows a side view of the planter system that shows an exploded view of the supporting bars and wheels;

FIG. 3 shows a side plan view of the planter system of the invention, showing the top array connected to the lower array with a lighting system;

FIG. 4 shows a side view of the two reservoirs connecting forming an array;

FIG. 5 shows a side view of the two reservoirs connection system that shows an exploded view of the mounting trays, container clip, and handle;

FIG. 6 shows a top view of the reservoir with the permeable partition in place;

FIG. 7 shows a cross section view of the reservoir with the permeable partition removed;

FIG. 8. shows an exploded view of the reservoir and the permeable partition;

FIG. 9. shows a side view of an array with the raiser showing how the volume of the reservoirs may be increased, also illustrating how a single array may be utilized;

FIG. 10. shows a close up view of the an opening showing the screw threads;

FIG. 11 show a cross section view of the reservoir with the permeable partition

FIG. 12 shows a side plan view of the planter system showing how the different arrays may be stacked.

### DRAWING REFERENCE NUMBERS

| | |
|---|---|
| 4 | planter system |
| 6 | upper array |
| 8 | lower array |
| 10 | reservoir |
| 12 | mounting tray |
| 13 | light accessory |
| 14 | support bar |
| 15 | riser |
| 16 | container clip |
| 17 | container handle fastener |
| 18 | wheel |
| 22 | mounting guides |
| 24 | accessory connectors |
| 30 | permeable partition |
| 32 | partition cup |
| 34 | partition cup openings |
| 36 | partition openings |
| 46 | second volume |
| 48 | first volume |
| 50 | first sidewall |
| 52 | second sidewall |
| 54 | front lateral wall |
| 56 | back lateral wall |
| 57 | rim |
| 58 | access notch |
| 60 | ledge |
| 62 | first opening |
| 63 | screw threads |
| 64 | front handle |
| 65 | side handle |
| 66 | bar receiver |
| 67 | bar mounting guide |
| 68 | channel |
| 70 | perforated wall |
| 72 | accessory mount |
| 74 | raised platform |
| 76 | second opening |
| 78 | bottom |
| 80 | mounting tray guild |

### DESCRIPTION

The following discussion describes embodiments of the invention and several variations of these embodiments. This discussion should not be construed, however, as limiting the invention to these particular embodiments. Practitioners skilled in the art will recognize numerous other embodiments as well. It is not necessary that the planter system have all the features described below with regard to the specific embodiment of the invention shown in the figures.

In the following description of the invention, certain terminology is used for the purpose of reference only, and is not intend to be limiting. Terms such as “upper”, “lower”, “above”, and “below,” refer to directions in the drawings to which reference is made. Terms such as “inwards” and “outward” refer to directions towards and away from, respectively, the geometric center of the component described. Terms such as “side”, “top”, “bottom,” “horizontal,” and “vertical,” describe the orientation of portions of the component within a consistent but arbitrary frame of reference which is made clear by reference to the text and the associated drawings describing the component under discussion. Such terminology includes words specifically mentioned above, derivatives thereof, and words of similar import.

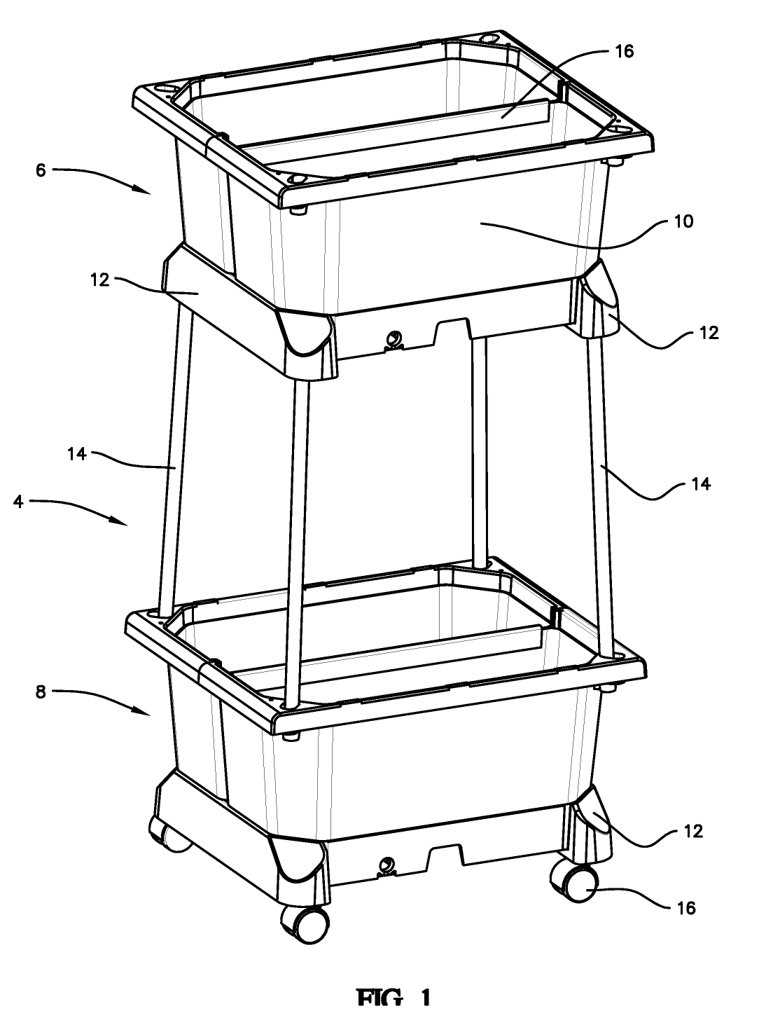

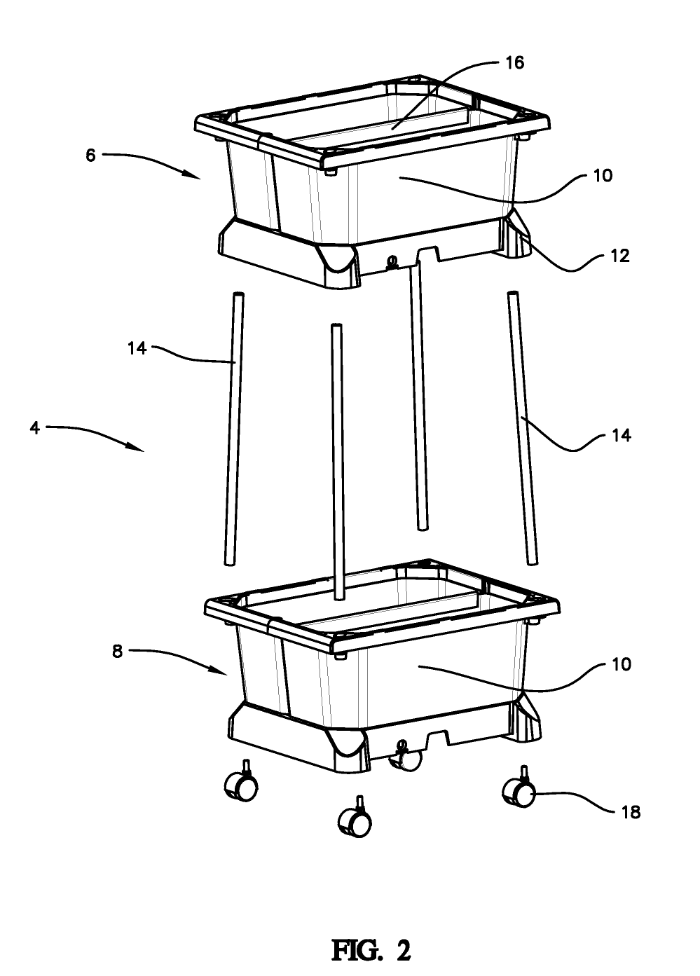

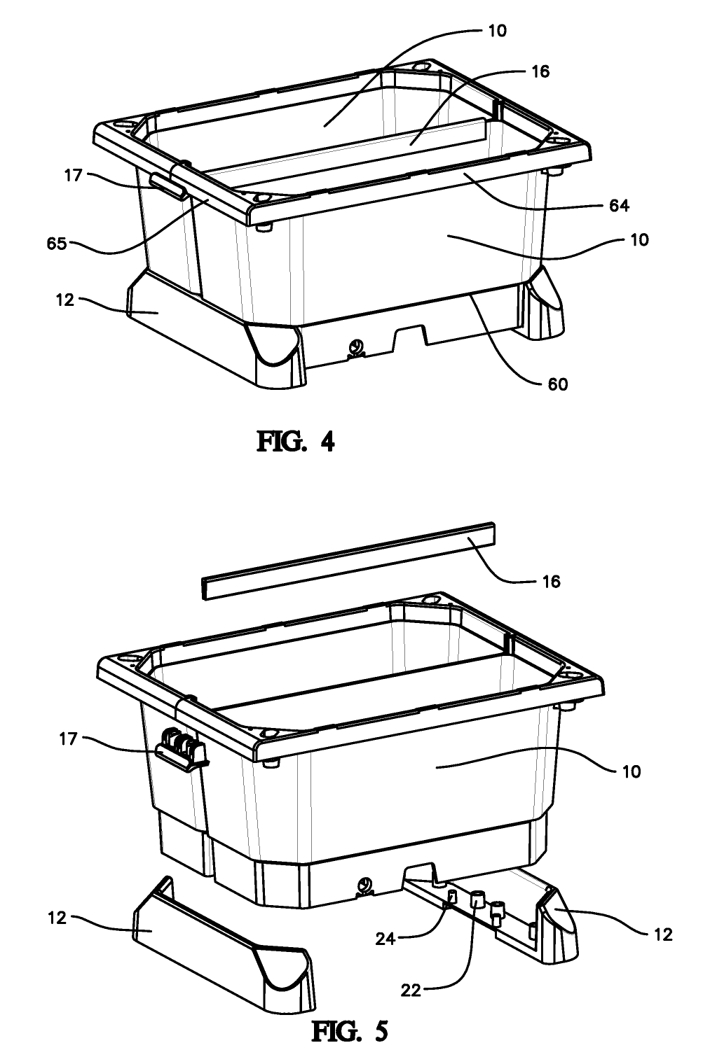

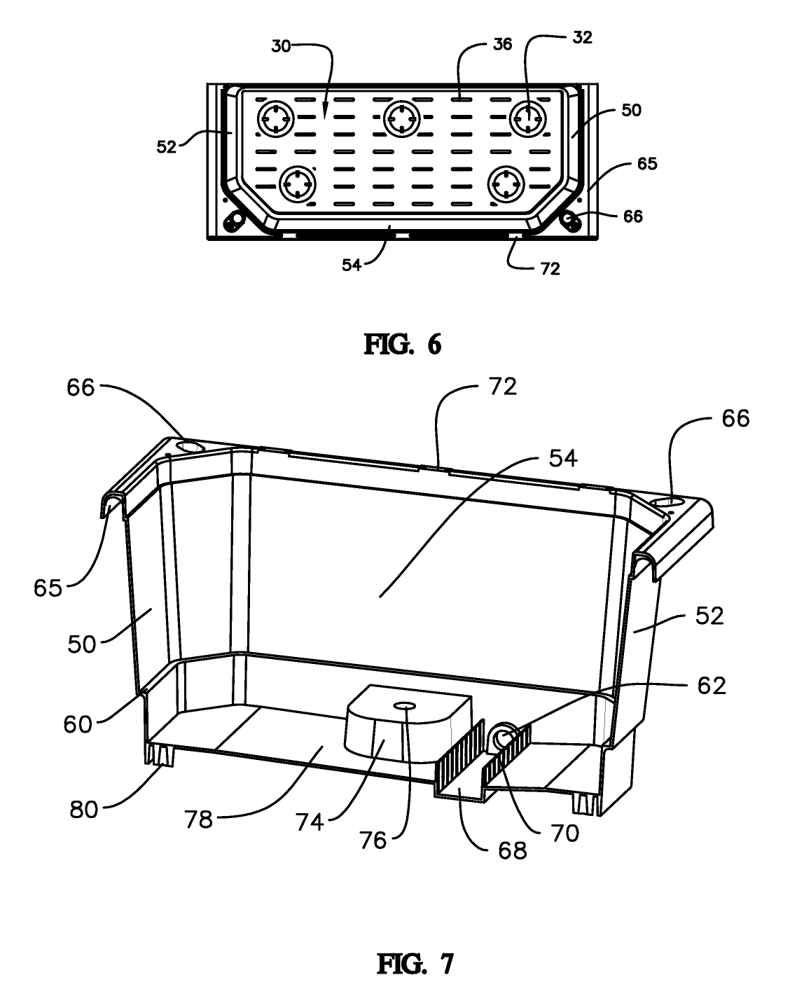

Referring generally to FIGS. 1 through 10, a reservoir container 10 comprises a front lateral wall 54, a back lateral wall 56, a first side wall 50, a second side wall 52 and a bottom 78 forming a shaped interior volume structure. FIG. 6 through 8 show an optional beveled corner at the junction of the front lateral wall 54 and the first side wall 50 and second side wall 52.

Located at the top of the front lateral wall 54, the first side wall 50, and the second side wall 52 is a rim 57. The rim 57 on the front lateral wall 54 forms a front handle 64. The rim 57 on the first side wall 50 and the second side wall 52 forms two side handle 65. The front handle 64 and the side handle 65 are sufficiently wide to allow the user to comfortably grasp and hold the reservoir container 10. Located on the rim 57 is a bar receiver 66. As described in detail below, the bar receiver 66 is for receiving a support bar 14. At least one accessory mount 72 is located at various locations on the rim 57. The accessory mount 72 comprises screw holes and a mounting surface to attach the accessory to the reservoir containers 10.

The interior volume of the reservoir containers 10 is divided by a penetrable partition 30 forming a first volume 48 and a second volume 46. The penetrable partition 30 is removable by the user. As shown in FIG. 9, a riser 15 may be connected to the reservoir container 10 to increase the capacity of the second volume 46. The penetrable partition 30 has at least one penetrable opening 36. The penetrable opening 36 dimension is such that growing medium (not shown) is prevented from falling into the first volume 48, but still allows liquids to flow through the penetrable opening 36. The penetrable partition 30 is supported by at least two partition cup 32 that extends into the reservoir container 10 and a ledge 60.

The partition cup 32 extends the penetrable partition 30 into the cavity of the first volume 48. The partition cup 32 has at least one partition cup opening 34. The size of the partition cup opening 34 is similar to the penetrable opening 36. The partition cup 32 allows the growing medium to extend into the first volume 48, which will allow the growing medium to wick water up into the growing medium. Generally, the partition cups 32 is molded from the same material as the penetrable partition 30.

Those skilled in the art will recognize that the number, size, location or location of the penetrable openings 36, the partition cups 32, the first volume 48, the second volume 46, and the partition cup openings 34, may vary based upon the growing medium, plant types, and water conditions.

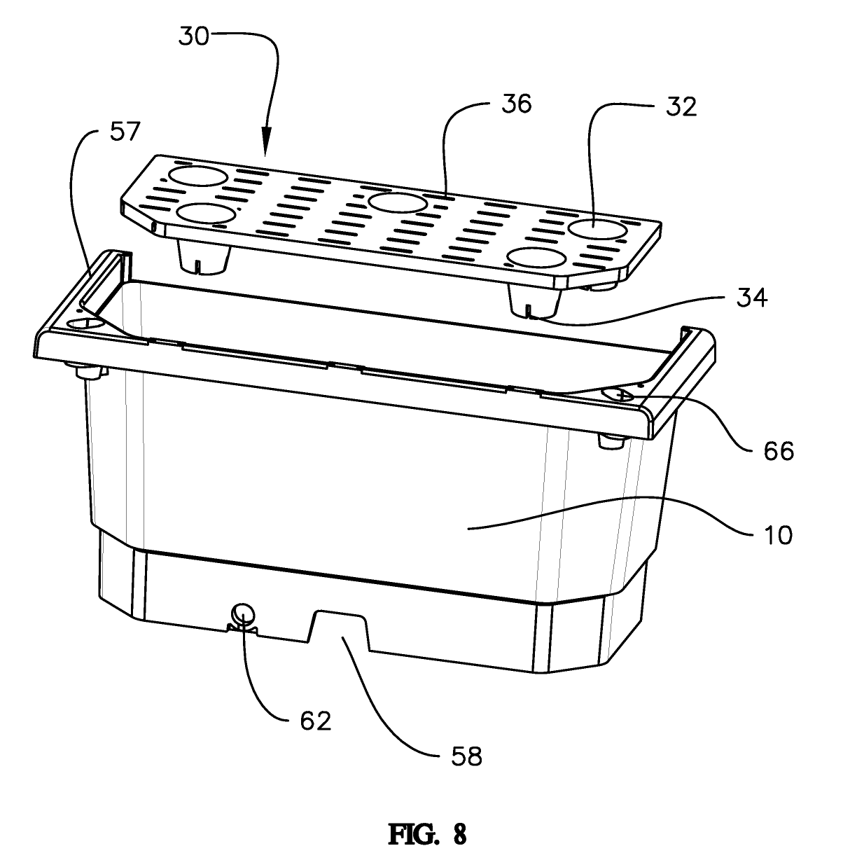

As shown in FIG. 8, a channel 68 is located at the interior base of the reservoir 10. At least a portion of the channel 68 has a perforated wall 70. The perforated wall 70 allows liquids to drain into the channel 68, yet still contain items such as gravel or filters in the channel 68 or alternatively to keep gravel or filter material out of the channel 68. Located in the channel 68 is a first opening 62. The first opening 62 allows for the base of the container to drain liquids or debris from the reservoir 10. The reservoir bottom 78 is sloped that directs liquid towards the channel 68.

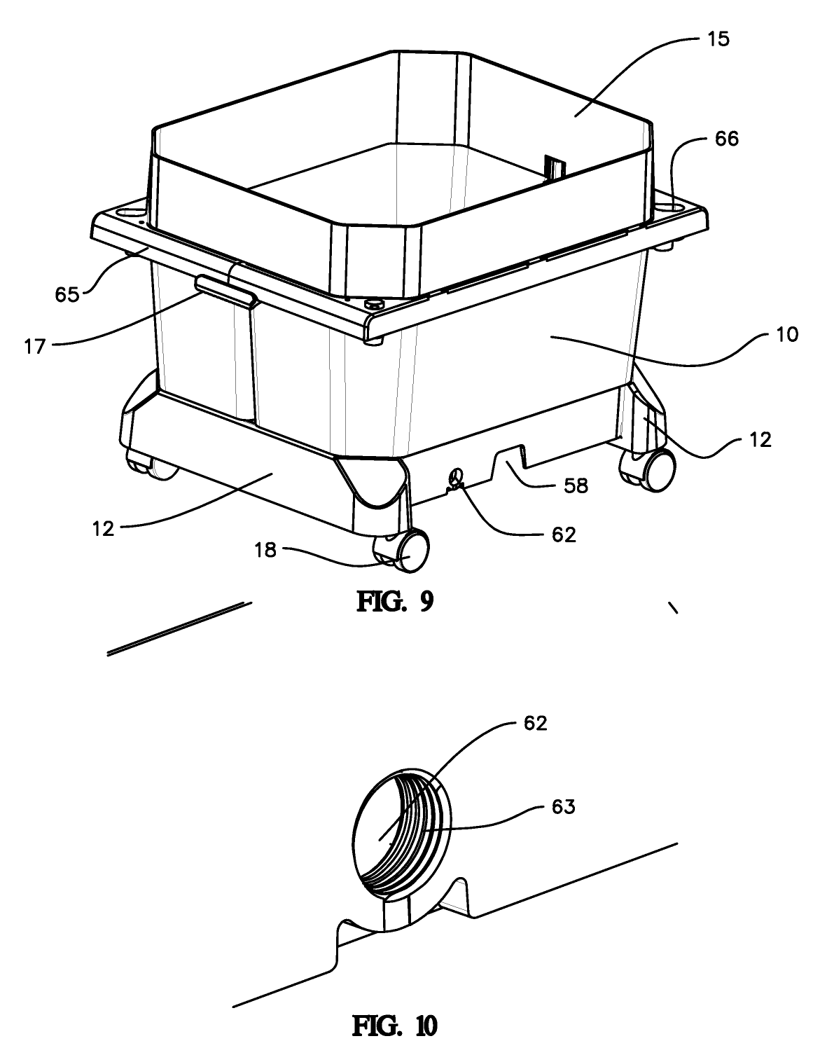

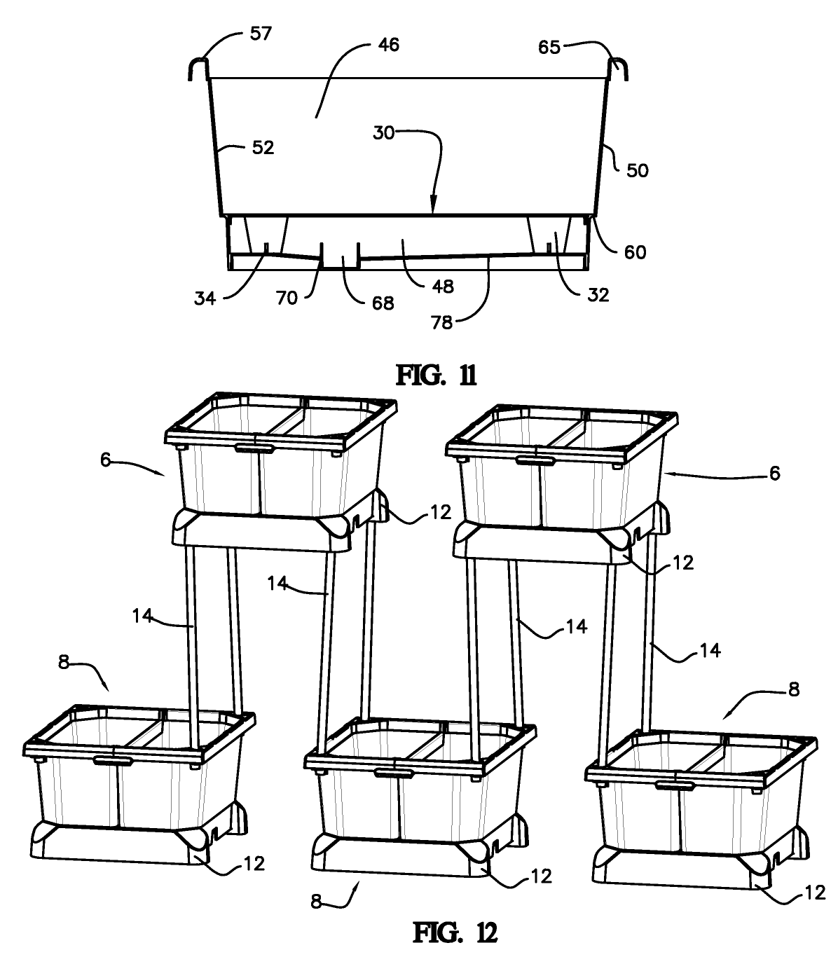

A second opening 76 is generally elevation higher than the first opening 62. As shown in FIG. 8 the second opening 76 may be located on a raised platform 74. The second opening 76 is generally used to allow liquids to flow into the reservoir 10 or to function as an overflow opening. As seen in FIG. 10 the first opening 62 and second opening 76 may have a screw thread 63.

The features of the reservoir 10 give the user almost unlimited options for configurations of different planting options. For example the first opening 62 and the second opening 76 allow different options for optimizing the water conditions or may be connected to a pipe system to create a hydroponic system (not shown). Preferably, all items including the reservoir 10, penetrable partition 30, and riser 15 are manufactured from a plastic material utilizing molding methods, although any ridged material may be utilized.

The reservoir 10 may be arranged into a planter system 4 that includes an upper array 6 and a lower array 8. The support bar 14 connects the upper array 6 and lower array 8 together. The interrelationship of the components is best seen in FIG. 1.

The lower array 8 consists of two mounting trays 12 and two reservoirs 10. The mounting trays 12 contain a mounting guide 22 that connects into a mounting receivers 80 located at the bottom of the reservoir 10. The mounting guides 22 have a slightly smaller circumference than the mounting receivers 80. When the mounting guides 22 are placed inside the mounting receivers 80, the friction between the mounting guides 22 and the sidewall of the mounting receivers 80 is such that a deliberate force is required to remove the reservoir containers 10 from the mounting guides 22. The length of the mounting tray 12 is such that it may connect two reservoir containers 10 together. The upper array 6 has a similar configuration as the lower array 8. The mounting trays 12 gives the upper array 6 and lower array 8 a wider stance that increase the stability of the planter system 4.

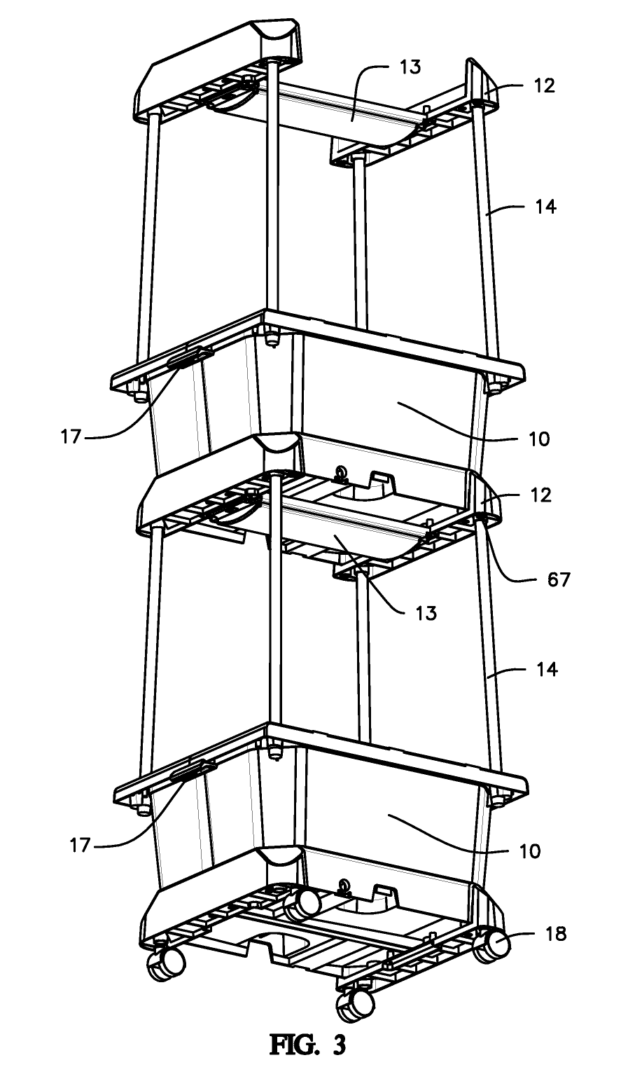

The upper array 6 is elevated above the lower array 8 by means of a plurality of support bars 14. The support bars 14 connect with the lower array 8 in a bar receiver 66 located on the reservoir 10 rim 57. A bar mounting guide 67 located the underside of the mounting tray 12 connects to the support bar 14 to the upper array 6. FIG. 3, shows the invention of the planters system 8 as including a light 13 elevated above both the lower array 8 and the upper array 6.

A container clip 16 and a container handle fastener 17 reinforces the connection between the two reservoir containers 10. The container clip 16 is a u-shaped fastener that connects the back lateral walls 56 of two reservoir containers 10. The container clip 16 applies a compressive force to the back lateral walls 56 of each reservoir container 10. The container handle fastener 17 is located under the side handle 65. Half the container handle fastener 17 is placed within the side handle 65 of a reservoir 10, while the other half of the handle fastener 17 is located in the side handle 65 of the adjoining reservoir 10.

All the connections are preferably secured by friction between the parts such that a deliberate force will be required to remove the parts. However, it is envisioned that the parts may be mechanically connected by means of a screw or both. In the alternative, the parts may be permanently connected.

While a preferred embodiment of the invention of the plant cultivation apparatus has been shown and described herein, it should, however, be understood that the description above contains many specificities that should not be construed as limiting the scope of the invention. Thus, the scope of the embodiment should be determined by the appended claims and their legal equivalents thereof, rather than by the examples given.

What is claimed is:

1. A planter comprising:
(a) a reservoir container forming a shaped interior volume structure;
(b) a removable permeable partition which separates the reservoir container into a first chamber and a second chamber, whereby the first chamber is located in the base of the reservoir container, the second chamber is located above the permeable partition, wherein the permeable partition contains plant growing medium in the second chamber;
(c) a canal located in the first chamber on the base interior of the reservoir container, the canal having a canal wall that extends upward into the first chamber, at least a portion of the canal wall is perforated;
(d) the reservoir container has a first opening and a second opening both located in the first chamber, the first opening is positioned within the canal and, the second opening is located at an elevation greater than said first opening;
whereby, liquid located in the second chamber may drain through the permeable partition into the first chamber, liquid located in the first chamber may drain through the perforated canal wall, and out of the reservoir container through the first opening.

2. The invention as recited in claim 1, wherein said canal is the lowest interior elevation of said reservoir container.

3. The invention as recited in claim 1, wherein said canal longitudinal axis is perpendicular the longitudinal axis of said reservoir container.

4. The invention as recited in claim 1, wherein said permeable partition contains at least one partition cup that extends into said first chamber, whereby growing medium extends into the first chamber.

5. The invention as claimed in claim 4, wherein said partition cup have at least one perforated cup opening.

6. The invention as claimed in claim 4, wherein said permeable partition is supported by said partition cups.

7. The invention as claimed in claim 1, wherein said second opening is located on a raised platform.

8. The invention as claimed in claim 1, wherein said second volume is increased by a riser connected to said reservoir.

9. The invention as claimed in claim 1, wherein said reservoir and said permeable partition is made of plastic.

10. The invention as claimed in claim 1, wherein a rim is located around at least a portion of the upper circumference of said reservoir container.

11. The invention as claimed in claim 10, wherein said rim contains an accessory mount.

12. The invention as claimed in claim 1, wherein said first opening and said second opening have screw threads.
